(19) United States
(12) Patent Application Publication
(10) Pub. No.: US 2008/0263929 A1
(43) Pub. Date: Oct. 30, 2008

(54) Hunting and Observation Blind

(76) Inventors: Richard A. Fiore, Tucson, AZ (US); Gregory Huebl, Tucson, AZ (US)

Correspondence Address: QUARLES & BRADY LLP, ONE SOUTH CHURCH AVENUE, SUITE 1700, TUCSON, AZ, 85701-1621, US

(21) Appl. No.: 11/740,174

(22) Filed: Apr. 25, 2007

(51) Int. Cl. A01M 31/00

(52) U.S. Cl. 43/1

(57) ABSTRACT

A portable hunting blind that includes a sheet depicting an animal on a front side, a plurality of rods coupled to a back side for supporting the sheet, and an opening in the sheet suitable for extending equipment therethrough. A sideways-T configured opening in the sheet, a rest for supporting an item of equipment within the opening, and flaps cut into the sheet for air to pass through also are disclosed.

### BACKGROUND OF THE INVENTION

1. Field of the Invention

This invention generally relates to an apparatus for concealing a person while observing or hunting wildlife.

2. Description of the Related Art

In hunting for wild game or observing wild animals generally, it is desirable to blend in with the surrounding environment. Animals become accustomed to the appearance of their habitat and become wary of anything that appears foreign. This animal tendency has given rise to the use of shelters, referred to as blinds, which appear as part of a natural environment. Thus, blinds of various kinds have been developed to help ensure that a hunter or observer will not spook or discourage animals from moving within proximity to the blind.

Additionally, it is known that game animals, such as deer or elk, are not frightened or suspicious of certain animals (and especially domesticated animals). Thus, blinds have been created in the image of animals such as cows, sheep, and the like.

The need for a blind that can be easily collapsed and carried into the field even by a single hunter has been identified for quite some time. However, known approaches at creating a portable blind that is easy to carry into the field and includes the image of an animal have been only partially successful, in that known devices are made from rigid sections that collapse, “puff,” or otherwise appear unnatural when there is a wind blowing. For example, U.S. Pat. No. 6,296,005 issued to Williams et al. discloses a collapsible blind that is constructed very much like an umbrella. While it may be suitable for its intended purpose, this blind appears to be vulnerable to blowing over or puffing up in windy conditions. Furthermore, a user of this blind would have a difficult time holding the blind in place or moving the blind while simultaneously using equipment or firing a weapon from a concealed position.

In addition, there are devices, such as the blind illustrated in U.S. Pat. No. 5,943,807 to McPherson, which use looped spring-steel for a “twist-fold” effect that allows rapid deployment of the blind. This type of device, however, suffers from the limitations imposed by the “twist-fold” structure, in that the shape of the blind is restricted by the shape of the “twist-fold” spring. Furthermore, while the “twist-fold” loops can be compacted, the amount of compaction achievable is limited due to the fact that a spring of sufficient stiffness to support a flat panel of a size that is large enough to conceal an entire human will be limited as to the minimum size to which it can be compacted.

Thus, there continues to be a need for new and improved blinds that are portable and that are especially well suited for hunting and observation applications in the wild by being adapted to use in wind and by providing for the simultaneous use of equipment while holding or moving the blind in a concealed position.

### SUMMARY OF INVENTION

The invention relates in general to a portable blind apparatus that includes a sheet depicting an animal on the front side, a plurality of rods coupled to the back side of the sheet, and an opening disposed within the sheet. More particularly, the blind may include a plurality of flaps cut into the sheet and adapted to allow air flow therethrough, a specially configured opening, and/or means for supporting or attaching equipment to the blind such that the equipment may be operated or fired through the opening without revealing the user and without the user otherwise supporting the blind.

In one embodiment of the invention, the blind apparatus includes a sheet depicting a cow on the front side of the sheet, a plurality of rods coupled to and supporting the back side of the sheet, an opening disposed within the sheet, and a plurality of flaps cut into the sheet and adapted to allow air flow therethrough.

In another embodiment of the invention, a sideways-T configured opening is disposed within the sheet to support the use of specialized equipment (such as optics on a bow for use with arrows). The blind apparatus may further include a rod that substantially bisects the opening and contains a rest disposed thereon. The rest may be in slidable engagement with the bisecting rod to allow adjustment of the height or angle of the equipment contacting the rest.

In yet another embodiment of the invention, the blind apparatus includes a sheet depicting an animal on the front, a plurality of rods coupled to and supporting the back of the sheet, and both a sideways-T configured opening and a plurality of flaps cut into the sheet to allow air flow therethrough.

Embodiments of the invention further may include a strap or other fastening member being adapted to attach a bow to the sheet such that the bow is positioned substantially vertically for firing through the opening.

Thus, it will be appreciated that the apparatus of the invention provide new and improved blinds for multiple outdoor activities.

### BRIEF DESCRIPTION OF THE DRAWINGS

FIG. 1 schematically illustrates in elevational view a preferred design appearing on the front of some embodiments of the invention.

FIG. 2 schematically illustrates in elevational view the back side of an embodiment of the invention.

FIG. 3 is an exploded plan-view of an embodiment of the invention.

FIG. 4 illustrates the embodiment of FIG. 3 in assembled form.

### DETAILED DESCRIPTION OF THE PREFERRED EMBODIMENTS

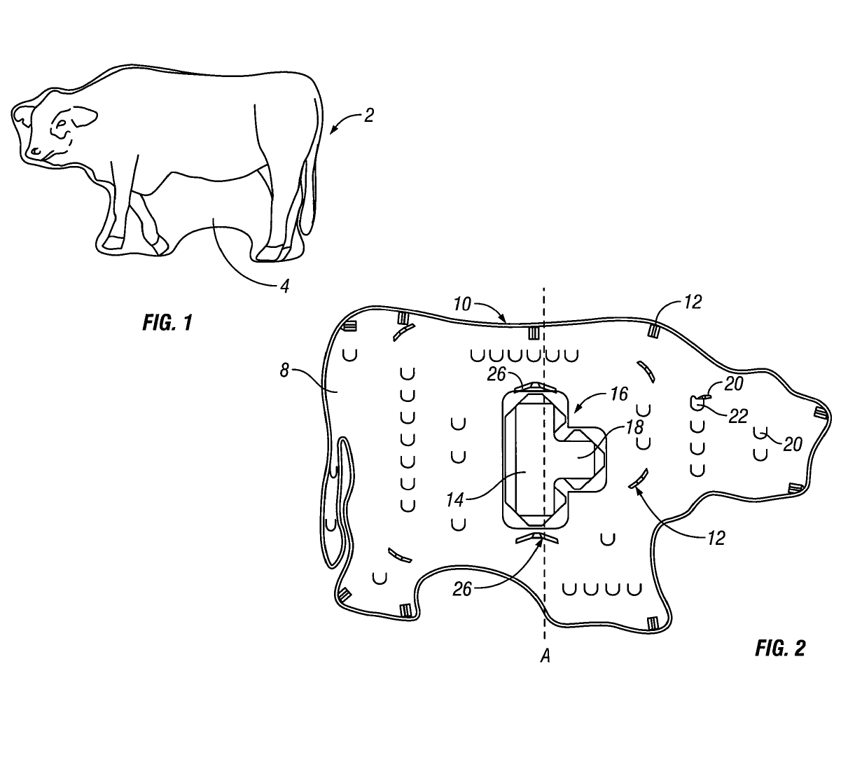

Turning to FIG. 1, a sheet 2 depicting an animal (in this case a cow) on the front side 4 of the sheet 2 is shown. The sheet 2 preferably is made from a light weight material, such as rip-stop nylon, that can have an animal image printed on or adhered to the front side. This sheet 2 is then provided with an opening, support rods, and other features described in more detail below.

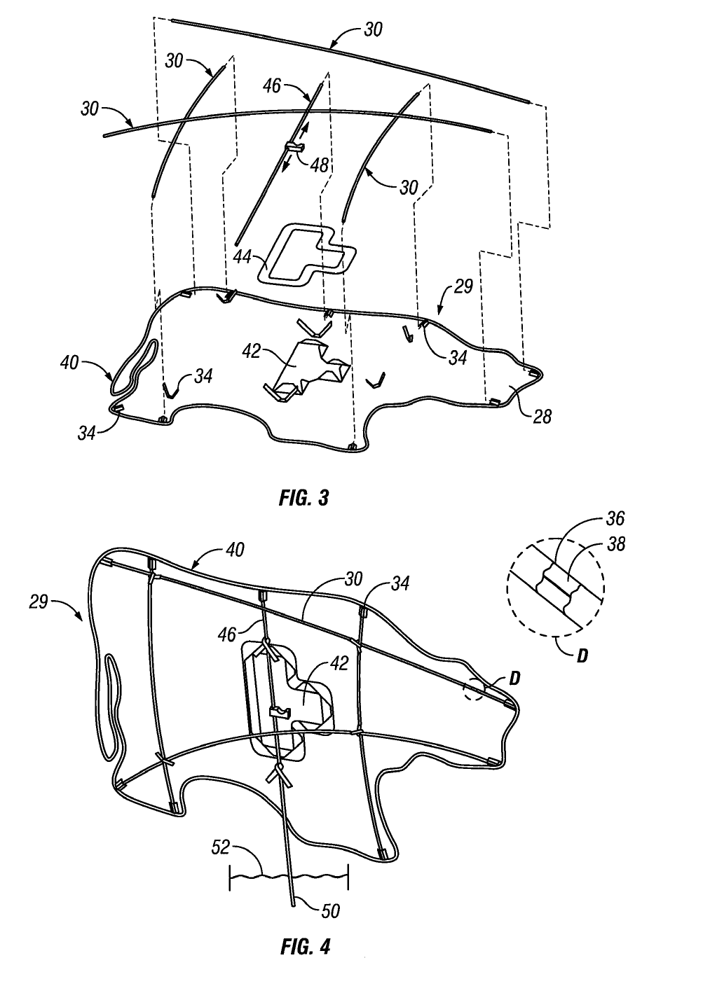

As seen in FIG. 2, the back side 8 of sheet 10 has a plurality of holders 12 coupled to sheet 10 for attachment of the rods (see FIG. 3) that support the sheet in a fully extended configuration. An opening 14 is cut or otherwise formed within the sheet. In this embodiment, the opening is a “sideways-T configuration” 16, which enables a person to use bow optics or other specialized equipment that is not easily used with a small rectangular or circular opening. Advantageously, auxiliary equipment can used from the smaller portion 18 of the sideways-T configuration 16 without the overall opening 14 being made so large that the person behind the sheet is not as effectively screened.

A plurality of flaps 20 are cut into the sheet 10 such that air flows through the resulting aperture 22 when wind blows upon a flap 20. Preferably, each flap 20 is approximately 1 inch in height and width so that air can flow through the sheet 10 without creating an obvious visual distraction. The overall effect of the flaps 20 is in the prevention of “puffing” distortion of the sheet 10 and in allowing the user more freedom of operation (e.g., to observe, track, or sight animals without having to constantly hold on to the blind for fear of the wind knocking it over).

The back side 8 of sheet 10 further includes an attachment means, such as straps 26. In this embodiment, straps 26 are adapted to attach a bow to sheet 10 such that the bow is positioned substantially vertically for firing through the opening 14 as indicated by axis A. The straps 26 preferably are made of doubled-sided hook-and-loop fasteners and are stitched with heavy-duty thread to sheet 10. Thus, the blind can be supported solely by the attached bow, allowing a hunter to move the blind while maintaining readiness to fire the bow.

In order to provide balance to the blind, preferably opening 14 is disposed upon the sheet such that the weight of the apparatus on either side of the vertical axis A running through the opening is substantially equal.

Turning to FIGS. 3 and 4, an exploded and assembled view of another embodiment is shown, respectively. On the front side of the blind is a cow image (not shown) similar to that seen in FIG. 1. On the back side 28 of sheet 29 are a plurality of rods 30 coupled to holders 34. Preferably, the rods 30 are collapsible shock-cord poles 36 (shown in a partially cut-away section 38 in magnified detail D). Also preferably, the holders 34 are configured such that only each end of the rods 30 is located proximal to a perimeter edge 40 of sheet 29 (rather than the rods extending around the perimeter edge).

Disposed within sheet 29 is a sideways-T configured opening 42. The opening 42 preferably is strengthened by attaching a reinforcing member 44 within the opening. In this embodiment, opening 42 further includes a rod 46 that substantially bisects the opening, with the bisecting rod 46 having a rest 48 disposed thereon. The rest 48 preferably is disposed in slidable engagement (indicated by the arrows around rest 48 in FIG. 3) with the bisecting rod so that a gun barrel or other piece of equipment (not shown) is adjustably supported by being placed thereon.

The invention as shown in FIG. 4 further includes a pole 50 that extends from a bottom area of sheet 29. The pole helps to maintain the sheet in a substantially vertical position relative to a ground surface 52, upon or within which the pole is placed.

While the invention is contemplated for use primarily for hunting applications, alternatively the invention may be used in conjunction with observation, photography, or other activities. Hence, sound, camera, or other equipment may be supported by the rest or affixed to the apparatus with the strap or other attachment means.

Various changes in the details that have been described may be made by those skilled in the art within the principles and scope of the invention herein described in the specification and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products.

What is claimed is:

1. A portable blind apparatus, comprising:
a sheet depicting an animal on a front side and being supported by a plurality of rods coupled to a back side;
an opening disposed within said sheet, and
a plurality of flaps cut into the sheet and adapted to allow air flow therethrough.

2. The apparatus of claim 1, wherein said opening comprises a sideways-T configuration.

3. The apparatus of claim 1, wherein said plurality of rods comprise collapsible shock-cord poles.

4. The apparatus of claim 1, wherein said opening further includes a rod that substantially bisects said opening, said bisecting rod having a rest disposed thereon.

5. The apparatus of claim 4, wherein said rest is disposed in slidable engagement with said bisecting rod.

6. The apparatus of claim 1, wherein said back side of the sheet further comprises a fastening member being adapted to attach a bow to said sheet such that the bow is positioned substantially vertically for firing through the opening.

7. The apparatus of claim 1, further including a pole that extends from a bottom area of said sheet, the pole being adapted to maintain the sheet in a substantially vertical position relative to a ground surface.

8. The apparatus of claim 1, wherein only each respective end of said rods is disposed proximal to a perimeter edge of said sheet.

9. The apparatus of claim 1, wherein said opening is disposed upon the sheet such that the weight of the apparatus on either side of a vertical axis running through the opening is substantially equal.

10. A portable blind apparatus, comprising:
a sheet depicting an animal on a front side and being supported by a plurality of rods coupled to a back side; and
a sideways-T configured opening disposed within said sheet.

11. The apparatus of claim 10, further comprising a plurality of flaps cut into the sheet and adapted to allow air flow therethrough.

12. The apparatus of claim 10, wherein said plurality of rods comprise collapsible shock-cord poles.

13. The apparatus of claim 10, wherein said opening further includes a rod that substantially bisects said opening, said bisecting rod having a rest disposed thereon.

14. The apparatus of claim 13, wherein said rest is disposed in slidable engagement with said bisecting rod.

15. The apparatus of claim 10, wherein said back side of the sheet further comprises a fastening member being adapted to attach a bow to said sheet such that the bow is positioned substantially vertically for firing through the opening.

16. The apparatus of claim 10, further including a pole that extends from a bottom area of said sheet, the pole being adapted to maintain the sheet in a substantially vertical position relative to a ground surface.

17. The apparatus of claim 10, wherein only each respective end of said rods is disposed proximal to a perimeter edge of said sheet.

18. The apparatus of claim 10, wherein said opening is disposed upon the sheet such that the weight of the apparatus on either side of a vertical axis running through the opening is substantially equal.

19. A portable blind apparatus, comprising:
a sheet depicting an animal on a front side and being supported by a plurality of rods coupled to a back side;
a sideways-T configured opening disposed within said sheet; and
a plurality of flaps cut into the sheet and adapted to allow air flow therethrough.

20. The apparatus of claim 19, wherein said opening is disposed upon the sheet such that the weight of the apparatus on either side of a vertical axis running through the opening is substantially equal.
